(19) United States
(12) Patent Application Publication
(10) Pub. No.: US 2004/0162829 A1
(43) Pub. Date: Aug. 19, 2004

(54) Information management system for remote computing platforms

(75) Inventors: John S. Gabos, Minnetonka Beach, MN (US); Douglas A. Olson, Eden Prairie, MN (US); Kirk W. Dybvik, Chaska, MN (US)

Correspondence Address: MERCHANT & GOULD PC, P.O. BOX 2903, MINNEAPOLIS, MN, 55402-0903, US

(73) Assignee: Iceberg International, Inc., Minnetonka, MN

(21) Appl. No.: 10/745,895

(22) Filed: Dec. 23, 2003

Related U.S. Application Data
(63) Continuation of application No. 09/664,805, filed on Sep. 19, 2000, now abandoned.
(60) Provisional application No. 60/159,923, filed on Oct. 16, 1999.

(51) Int. Cl. G06F 7/00

(52) U.S. Cl. 707/10

(57) ABSTRACT

A computing system for managing information between a server computing environment and a remote computing platform is disclosed. The server computing environment distributes information relevant to a user to the remote computing platform. The remote computing platform is configured to allow the user to automatically access the information distributed from the server computing environment. For example, in one aspect, the computing system comprises a server application and a server database resident on the server computing environment and a first client application resident on the remote computing platform. The server application is configured to manage and arrange information relevant to a user stored in the server database and is capable of communicating with and distributing information to the remote computing platform. The client application resident on the remote computing platform is configured to create an association between the information distributed from the server database and one or more corresponding events stored on an application database resident on the remote computing platform. The client application is further configured to display each of the events stored on the application database such that the user can automatically access the information transferred from the server database using the association created by the client application.

### CLAIM TO PRIORITY UNDER 35 U.S.C. § 119(e)

Priority under 35 U.S.C. § 119(e) is claimed to provisional application serial No. 60/159,923, filed on Oct. 16, 1999, and entitled, “INFORMATION MANAGEMENT SYSTEM FOR REMOTE COMPUTING PLATFORMS.” The complete disclosure of application Ser. No. 60/159,923 is incorporated by reference herein.

### TECHNICAL FIELD

The present invention relates to computing systems and, more particularly, to a computing system for managing information between a server computing environment and a remote computing platform.

### BACKGROUND

The use of hand-held or otherwise portable computing devices has grown significantly over recent years. These devices allow users to remain mobile without losing access to important data. As a result, users are capable of managing important information and performing their required tasks while away from their homes or businesses.

For example, hand-held computing devices provide users with a variety of personal information management (“PIMs”) applications that allow users to remotely manage important information. Similarly, computing systems exist that allow users to access web-based server applications and data using a hand-held computing device. Typically, these systems require users to connect to an information server and download data to the hand-held computing device. Once the data is downloaded, the user can access and manipulate the data on their hand-held computer. The user can later re-connect to the information server and synchronize the data between the information server and the hand-held computing device.

While these systems increase the user's mobility with minimal constraints on their access to data, they have several key shortcomings. For instance, these systems do not allow managers of web-based server applications to determine whether the user actually accessed the downloaded information while it was remotely stored on the hand-held computing device. Managers of web-based server applications, therefore, have more difficulty tailoring future information to meet a particular user's needs. Moreover, because existing systems cannot ascertain what information users of hand-held devices are accessing, managers of web-based server applications are unable to accurately value the information their servers provide.

Moreover, there are on-line software applications that provide users with various calendar options. Typically, these applications store a user's calendar and appointments on a server. The user is able to modify their calendar using their hand-held computer or by connecting to the server with a desktop or laptop personal computer over the Internet and synchronizing the hand-held computer with the server. There are also applications that can copy the user's calendar from the server to their hand-held computer.

However, many of these systems do not generate or retrieve information for delivery to the user based upon the specific needs of the user. Instead, these applications merely maintain a separate and complete copy of the user's calendar in multiple locations. They are typically limited to a complete exchange of information, such as calendar information, between the server and the hand-held computer. The user, therefore, cannot download a discrete set of information into a large database that is stored on the hand-held computer. Moreover, the information in the calendars on either the server or the hand-held computer are not linked to external software applications. As a result, users of these systems are often required to manually enter data that is provided to them separate from their calendar applications.

### SUMMARY

In general terms, the present invention relates to a computing system for managing information between a server computing environment and a remote computing platform. The server computing environment distributes information relevant to a user to the remote computing platform. The remote computing platform is configured to allow the user to automatically access the information distributed from the server computing environment.

In one aspect, the computing system comprises a server application and a server database resident on the server computing environment and a first client application resident on the remote computing platform. The server application is configured to manage and arrange information relevant to a user stored in the server database and is capable of communicating with and distributing information to the remote computing platform. The client application resident on the remote computing platform is configured to create an association between the information distributed from the server database and one or more corresponding events stored on an application database resident on the remote computing platform. The client application is further configured to display each of the events stored on the application database such that the user can automatically access the information transferred from the server database using the association created by the client application.

In one aspect, the information on the server database includes information relevant to the user generated by the server application. In an alternative aspect, the information on the server database includes information relevant to the user received from one or more third-party computing systems. The information distributed from the server database to the remote computing platform can include one or more events and content information corresponding to each of the events.

In another aspect, each of the events transferred from the server database are transferred to a staging database resident on the remote computing platform and the content information corresponding to each of the events is transferred to a content database resident on the remote computing platform. In this aspect, the client application can be configured to process the events transferred to the staging database into the application database and create a record on an associative database for linking each event processed by the client application with the corresponding content information transferred to the content database resident on the remote computing platform.

In an alternative aspect, the server application can be configured to process the events distributed from the server database into the application database and create a record on an associative database. The record on the associative database links each event processed by the server application with corresponding content information distributed to the content database resident on the remote computing platform.

The user can automatically access the content information corresponding to a selected event using the association created by the client application. For example, the content information can be requested and retrieved directly to the client application when the user requests access to the content information using the association created by the client application. Alternatively, the client application can be configured to launch a second client application to provide access to the content information when the user requests access to the information using the association created by the client application.

The present disclosure also relates to a computing system for managing calendar events between a server computing environment and a remote computing platform. A server application is resident on the server computing environment and is configured to manage and arrange information relevant to a user stored in a server database. The server application communicates with the remote computing platform and is configured to distribute the information from the server database to the remote computing platform. The server application is further configured to process predetermined calendar events stored in an application database resident on the remote computing platform. A client application is resident on the remote computing platform and is configured to create an association between the information distributed from the server database and one or more corresponding calendar events stored on the application database. The client application is configured to display each of the calendar events stored on the application database such that the user can automatically access the information distributed from the server database using the association created by the client application.

In yet another aspect of the present disclosure, a method for managing information between a server computing environment and a remote computing platform is disclosed. In this aspect, the server computing environment includes a server application configured to manage and arrange information relevant to a user stored in a server database resident on the server computing platform. The method comprises the steps of distributing the information from the server database to the remote computing platform; creating an association between the information transferred from the server database and one or more corresponding events stored on an application database resident on the remote computing platform; and displaying each of the events stored on the application database such that the user can automatically access the information transferred from the server database using the association.

In still yet another aspect, the present disclosure relates to a computer-readable medium having computer-executable instructions for performing a method for managing information between a server computing environment and a remote computing platform.

In still yet another aspect, the present disclosure relates to a propagated signal on a carrier detectable by a computing system and encoding a computer program of instructions for executing a computer process for managing information between a server computing environment and a remote computing platform.

### BRIEF DESCRIPTION OF THE DRAWINGS

FIG. 1 is a high-level diagram illustrating a computing system for managing information between a server computing environment and a remote computing platform in accordance with the present disclosure;

FIG. 2 illustrates an exemplary server computing environment as shown in FIG. 1 capable of managing and arranging information in accordance with the present disclosure;

FIG. 3 illustrates an exemplary remote computing platform capable of communicating with the server computing environment of FIGS. 1 and 2 is shown;

FIG. 4 illustrates a detailed diagram illustrating the computing system for managing information between a server computing environment and a remote computing platform as shown in FIG. 1;

FIGS. 5A-5B depict a block diagram illustrating one possible embodiment of the computing system for managing information between a server computing environment and a remote computing platform in accordance with the present disclosure;

FIGS. 6A-6B depict a block diagram illustrating an alternative embodiment of the computing system for managing information between a server computing environment and a remote computing platform in accordance with the present disclosure;

FIG. 7 is a high-level flow chart illustrating the logical operations of the computing system for managing information between a server computing environment and a remote computing platform in accordance with the present disclosure;

FIGS. 8-10 are detailed flow charts illustrating the logical operations of the computing system for managing information between a server computing environment and a remote computing platform in accordance with the present disclosure; and

FIGS. 11-16 are screen shots illustrating various embodiments of a remote computing platform for use in accordance with the present disclosure.

### DETAILED DESCRIPTION

Various embodiments of the present computing system will be described in detail with reference to the drawings, wherein like reference numerals represent like parts and assemblies throughout the several views. Reference to various embodiments does not limit the scope of the computing system, which is limited only by the scope of the claims attached hereto.

The following discussion is intended to provide a brief, general description of a suitable computing environment for implementing the computing system of the present disclosure. It should be recognized that the computing system of the present disclosure may be practiced with many computer system configurations and platforms, such as hand-held computers or devices, laptop computers, desktop computers, or network personal computers. The term “hand-held computer” is used broadly to refer to hand-held computing platforms, palm-held computing platforms, mobile computing systems, such as those typically installed in automobiles, or any other computing platforms that a user can easily transport or carry. One skilled in the art will readily recognize that the claimed invention also can be implemented in other types of computing platforms as well.

The embodiments of the present computing system are implemented as logical operations in a distributed processing system having client and server computing systems. The logical operations of the present computing system are implemented: (1) as a sequence of computer implemented steps running on the computing system; and (2) as interconnected machine modules within the computing system. The implementation is a matter of choice dependant on the performance requirements of the computing system implementing the various embodiments of the invention and the components selected by or utilized by the users of the system. Accordingly, the logical operations making up the embodiments of the computing system described herein are referred to variously as operations, steps, or modules.

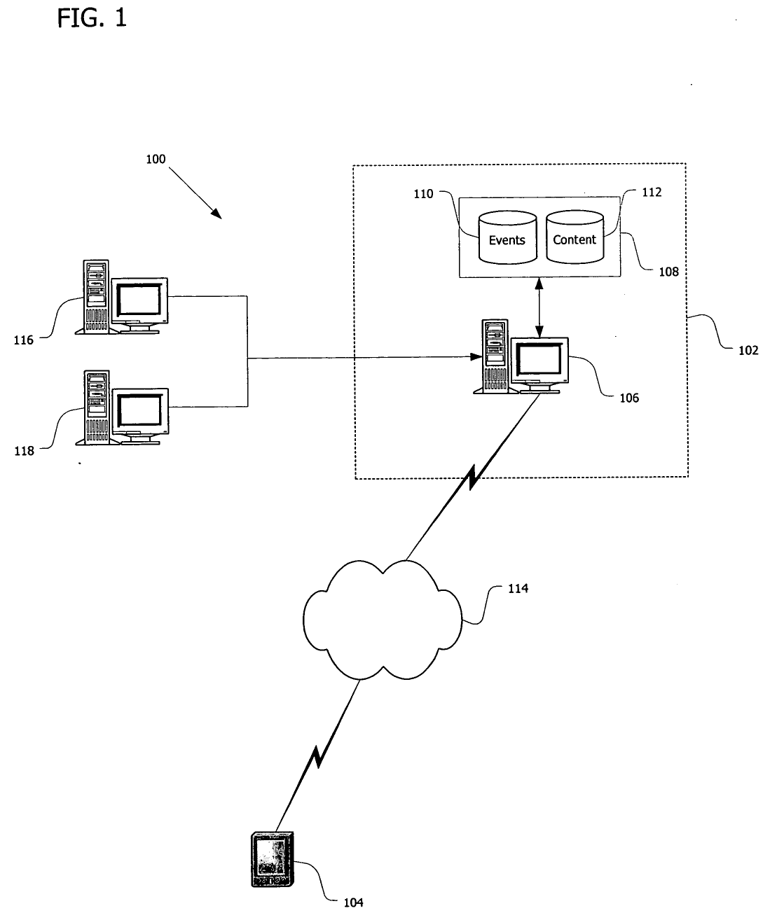

Now referring to FIG. 1, a computing environment 100 for implementing the system and method for managing information between a server computing environment 102 and a remote computing platform 104 is shown. The server computing environment 102 is configured to manage and arrange information relevant to a user. Information that is relevant to the user can include information managed and arranged by the server computing environment 102, such as information that the user has indicated an interest in, information considered of interest to the user based upon profile data supplied by the user or collected by the system, information directly related to a service being provided to and/or requested by the user, or other similar information.

In one possible embodiment, the server computing environment 102 includes a server computing system 106 and a server database 108 for storing the information relevant to the user. In this embodiment, the server computing system 106 is configured to manage and arrange information stored on the server database 108. For example, the server computing system 106 can manage and arrange event information 110 relevant to the user, such as calendar events, news events, advertisements, weather, local television listings, stock quote information, flight schedules and/or itineraries, entertainment event listings, as well as other similar information. Similarly, the server computing system 106 can also manage and arrange content information 112. The content information 112 typically includes detailed information associated with one or more corresponding events 110. The content information 112 can include information, such as detailed flight information, detailed weather information, detailed stock information, detailed information related to goods and/or services available in conjunction with a corresponding event, or other similar information.

The server computing system 106 is capable of communicating with the remote computing platform 104 and distributing or transferring information stored on the server database 108 to the remote computing platform 104. The server computing system 106 can be a general purpose and programmable computing system, such as an IBM-compatible personal computer. Preferably, the server computing system 106 is capable of performing tasks commonly handled by server computers, such as file and/or application management, network resource management, and other related services or tasks. The server computing system 106 typically has a resident operating system, such as those sold under the brand names Microsoft Windows™, Unix™, Linux™, DOS™, AIX™ or other similar operating systems.

The server computing environment 102 communicates with the remote computing platform 104 via a communications network 114. In one embodiment, the communications network 114 is the Internet. In an alternative embodiment, however, the communications network 114 is an intranet, local area network, wide area network, or other similar communications network capable of allowing a user to access the server computing environment 102 via the remote computing platform 104. Moreover, a user can access the server computing environment 102 via the remote computing platform 104 using a variety of connection types. For example, a user can access the server computing system 102 via a hard-wired connection, a direct-dial connection, a wireless connection (e.g., radio frequency or infrared), or other suitable connection types capable of allowing communication between the server computing environment 102 and the remote computing platform 104.

In one possible embodiment, the information managed and arranged by the server computing system 106 originates from one or more third party computing systems 116, 118. The information on the server database 108, therefore, includes information relevant to the user received from one or more third-party computing systems 116, 118. For example, the information on the server database 108 can include information relevant to the user that originates with an information content provider or service provider, such as AvantGo™, airline reservation systems, hotel reservation systems, automobile rental reservations systems, news information services, or any other third-party computing system. In so doing, the server computing system 106 is capable of aggregating information relevant to a user from various sources and facilitating the transfer of that information to the remote computing platform 104 as will be described in greater detail below.

Preferably, the remote computing platform 104 is a portable, palm-, or hand-held computer, such as a hand-held computer manufactured by Palm Computing or Handspring, Symbol, or Hewlett-Packard. However, it should be understood that the remote computing platform 104 can be any computing system suitable for communicating with and receiving information from the server computing environment 102 via the communications network 114. For example, the remote computing platform 104 can be any Windows CE™ brand operating system device, any Tablet PC™ brand device, any Palm™ operating system device, a laptop personal computer, a desktop personal computer, a wireless communications device, such as a web-enabled cellular telephone, or any other similar device.

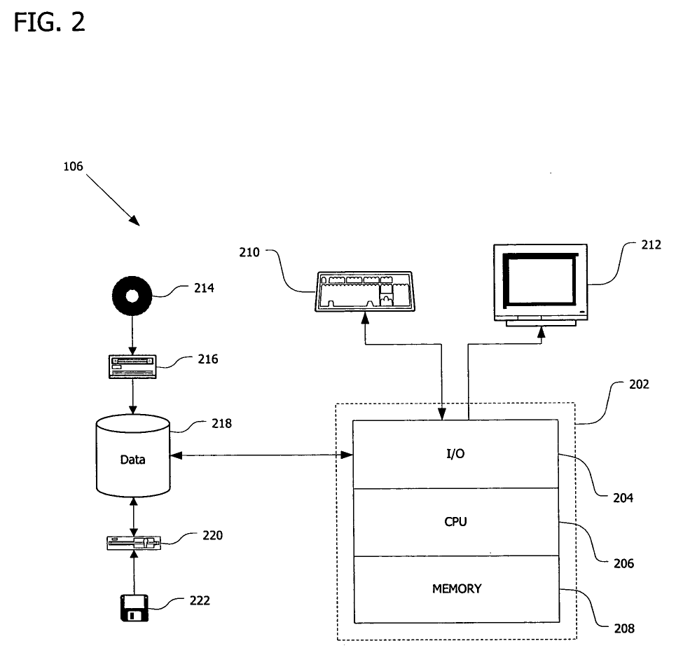

Referring now to FIG. 2, an exemplary server computing system 106 capable of managing and arranging information in accordance with the present disclosure is shown. As discussed above, the server computing system 106 is a general purpose and programmable computing system capable of performing tasks commonly handled by server computers. Furthermore, the server computing system 106 can operate using any suitable operating system. For example, the server computing system 106 can operate using operating systems including, but are not limited to, those sold under the brand names Microsoft Windows™, Unix™, Linux™, DOS™, AIX™, and other similar operating systems.

The server computing system 106 includes a processor 202 having an input/output section 204, a central processing unit (“CPU”) 206, and a memory section 208. The input/output section 204 is configured to receive input from and display output to various input/output devices or peripheral devices. For example, the input/output section 204 can be connected to a keyboard 210 to receive input from a user. Similarly, a magnetic storage device 218 capable of reading a magnetic storage medium 222 (e.g. floppy disk, tape, or other similar mediums) through a drive unit 220 also may be configured to operate with and supply input to the input/output section 204. Likewise, an optical disk drive unit 216 capable of reading information from or writing information to an optical storage medium 214 (e.g., CD-ROM, DVD, or other similar mediums) may also be configured to operate with the input/output section 204. The input/output section 204 can be configured to display output to a user. For example, the input/output section 204 can be connected to a monitor 212 to display information to a user. In addition to the peripheral devices identified above, the input/output section 204 may also contain a communications adapter (not shown) to enable communications across the communications network 114 (FIG. 1).

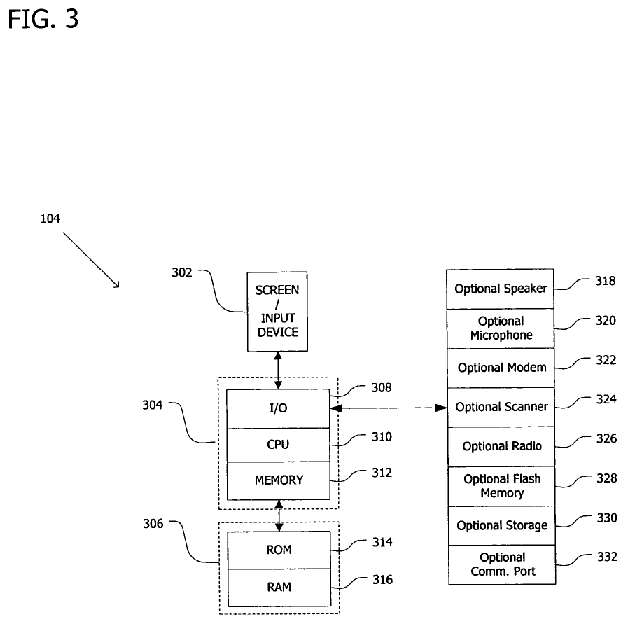

Now referring to FIG. 3, an exemplary remote computing platform 104 capable of communicating with a server computing environment is shown. As described above, the remote computing platform 104 is, preferably, a palm- or hand-held computer. The remote computing platform 104 can be any palm-sized computer, such as the palm-sized computers sold by Palm Computing or Handspring. However, it should be understood that the remote computing platform can be any other suitable device capable of communicating with the server computing environment, such as Palm™ operating system devices, Windows CE™ operating system devices, Tablet PC™ devices, laptop personal computers, desktop personal computers, cellular phones and/or electronic paging devices, or other similar device.

The remote computing platform 104 can include a screen/input device 302, a processor 304, and a memory section 306. The processor 304 includes an input/output section 308, a central processing unit (“CPU”) 310 operable with conventional computer memory 312. The input/output section 308 is configured to receive input from and display output to various input/output devices, components, or modules. For example, the input/output section 308 is configured to operate with the screen/input device 302. The screen/input device 302 can operate as an input device or an output device. Furthermore, the input/output section 308 can be configured to operate with optional devices, such as a speaker 318, a microphone 320, a modem 322, a barcode scanner 324, an optical scanner or other type of automatic identification reading device (not shown), a radio 326 for communications, flash memory 328 for additional information storage, or an additional storage area 330. Similarly, the remote computing platform 104 can be provided with a communications port 332 for communicating or interfacing with another computer or network. The communications port 332 can include an antenna for radio frequency communications, an infrared lens for infrared communications, or a port for direct physical attachment (e.g. via a cradle) to another computer or network.

The remote computing platform 104 also includes a memory section 306 for storing information accessible by the remote computing platform 104. The memory section 306 includes a read-only memory section (“ROM”) 314 and random access memory section (“RAM”) 316. In one embodiment, the information stored by the memory section 306 can include applications, such as web applications, business applications, personal information management (“PIM”) applications, as well as other applications. Furthermore, the remote computing platform 104 preferably can include a web browser installed for accessing and viewing the information transferred from the server database 108. For example, the remote computing platform 104 can includes a web browser, such as those sold under the brand names Microsoft Internet Explorer™, Netscape Navigator™, AvantGo™, or other similar applications.

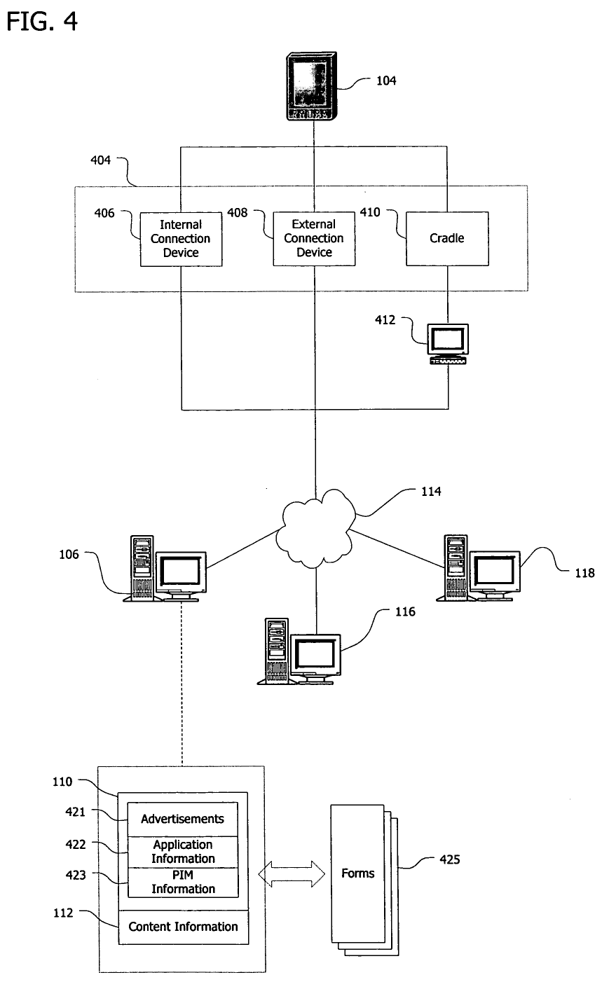

Referring now to FIG. 4, a detailed diagram illustrating a computing environment for implementing the system and method for managing information between the server computing environment and the remote computing platform is shown. In the embodiment illustrated in FIG. 4, the remote computing platform or hand-held computer 104 is capable of connecting to the server computing system 106 via the communications network 114 using one or more connection methods or connection points 404. For example, in one embodiment, the hand-held computer 104 is capable of connecting to the communications network 114 using an internal connection device 406, such a wireless internal modem or radio. In an alternative embodiment, the hand-held computer 104 is capable of connecting to the communications network 114 using an external connection device 408, such as a wireless external modem or a radio enabled connection device. In yet another alternative embodiment, the hand-held computer 104 is capable of connecting to the communications network 114 using a cradle 410 that is in communication with a personal computer 412. In this embodiment, the hand-held computer 104 can communicate with the cradle 406 using a variety of connection modes, including but not limited to, direct physical connection, infrared communications, radio frequency communications, or other supported modes.

In one embodiment, the connection points 404, including the internal connection device 406, the external connection device 408 or the cradle 410 are considered primary connection methods or connection points in which the user of the hand-held computing device 104 would own or have control of their respective network connection point. For example, the internal connection device 406, external connection device 408 or the cradle 410 would be controlled by the user and available at a primary connection location, such as the user's home or work location.

In an alternative embodiment, the connection points 404 are considered secondary connection methods or connection points in which the external connection device 408 or the cradle 410 are non-customer controlled. For example, in a situation where the user of the hand-held computing device 104 does not own or control the external connection device 408 or the cradle 410 used to access the server computing system 106, it generally can be considered a secondary connection method or point. In this case, the user can access the server computing system 106 despite not being at a primary connection location. Instead, the non-customer controlled connection points are preferably located away from the user's primary connection location. For example, the non-customer controlled connection points can be located in retail stores, schools, hospitals, post offices, sports stadiums, banks, airports, restaurants, hotels, athletic clubs, or various other locations.

The server computing system 106 distributes information relevant to the user to the hand-held computing device 104 through the communications network 114. As discussed above, information that is relevant to the user includes information distributed by the server computing system 106, such as information that the user has indicated an interest in, information considered of interest to the user based upon profile data supplied by the user or collected by the system, information directly related to a service being provided to and/or requested by the user, or other similar information. Specifically, as discussed above, the information can include event information 110 or content information 112. The event information 110 can include information, such as calendar events, news events, weather, local television listings, stock quote information, flight schedules and/or itineraries, entertainment event listings, as well as other similar information. For example, the event information 110 can include discrete and various types of information, such as advertisements 421, application information 422, and PIM information 423. The content information 112 typically includes detailed information associated with one or more corresponding events 110, such as detailed flight information, detailed weather information, detailed stock information, detailed information related to goods and/or services available in conjunction with a corresponding event, or other similar information.

The advertisements 421 provide information about a vendor's goods or services and can include coupons, offers to purchase goods or services, announcements, and/or other similar marketing related information. Moreover, upon receipt of an advertisement 421 on the remote computing platform 104, the user can select to receive additional information about the goods or products described in the advertisement 421. The application information 422 provides data that can be accessed and/or processed by an application located on the hand-held computer 104. The PIM information 423 includes information that can be accessed and/or processed by a PIM application resident on the hand-held computer 104. Examples of PIM applications that can be resident on the hand-held computer 104 include calendar, address book, to do list, memo, e-mail, or other comparable PIM applications.

Additionally, one or more forms or templates 425 can be provided to allow the user to display and access the information distributed by the server computing system 106 to the hand-held computing device 104. For example, in one embodiment, a form 425 can be provided to display the advertisements 421, the application information 422, the PIM information 423, or the content information 112. In an alternative embodiment, a form 425 can be provided to allow the user to request additional information from the server computing system 106. Similarly, a form 425 can be provided to allow the user to input data into the hand-held device 104. For example, a form 425 can be provided to allow the user to complete a survey, submit a purchase request or request additional services from the server computing system 106 or one of the third-party computing systems 116, 118.

In one embodiment, the server computing system 106 can distribute the information 110, 112 to the hand-held computing device 104 on-demand whereby the server computing system 106 distributes the information 110, 112 to the hand-held computing device 104 when the user makes a specific request to receive information from the server computing system 106. For example, information 110, 112 can be distributed from the server computing system 106 when the user requests to synchronize the hand-held computing device 104 with the server computing system 106 as is commonly understood in the art.

In an alternative embodiment, the server computing system 106 can automatically distribute the information 110, 112 to the hand-held computing device 104 when the user is “on-line” or already connected to the server computing system 106. In this embodiment, the server computing system 106 delivers the information 110, 112 to the hand-held computing device as the information 110, 112 is generated or becomes available to the server computing system 106. The server computing system 106 can be configured to distribute any available information 110, 112 from the server computing system 106 when the hand-held computer 104 is connected to the communications network 114. One skilled in the art will readily recognize that the claimed invention also can be implemented using various mechanisms for initiating the distribution of information from the server computing system 106 to the remote computing platform 104, such as scheduled information delivery, server-initiated delivery, or other similar mechanisms for distributing information.

In one embodiment, the user accesses and/or edits the information 110, 112 while the hand-held computing device 104 is “off-line.” In this embodiment, the user can access and/or edit the information 110, 112 while not connected to the server computing system 106. For example, the user can edit the information 110, 112 or form 425 that was distributed to the hand-held computer 104 from the server computing system 106. After the user has edited the information 110, 112 from the server computing system 106, the information 110, 112 is queued and returned to the server computing system 106 the next time the user connects to the server computing system 106.

Additionally, the user can enter a new request (e.g., for goods or services) using a form 425 to request information or additional services from the server computing system 106 or one of the third-party computing systems 116, 118. Likewise, the information 110, 112 distributed to the hand-held computer 104 can comprise a form 425 used to gather information from the user, such as a marketing survey (e.g., a product survey). In this case, the user can access a form 425 associated with the marketing survey while not connected to the server computing system 106. The form 425 will automatically be returned to the server computing system 106 upon the user's next connection to the communications network 114. Furthermore, a confirmation of this transaction can be returned to the hand-held computing device 104 when the server computing system 106 completes the transaction.

In one embodiment, the information 110, 112 is generated by the server computing system 106. Alternatively, it should be understood that the information 110, 112 distributed to the hand-held computing device 104 can be produced by one or more third-party computing systems 116, 118. For example, the third-party computing systems can include a customer computing system 116 in which the information 110, 112 is provided by a computing system where the user maintains an account, such as a travel agent, airline reservation system, hotel reservation system, news information system, stock information system, school class schedules, or similar computing system. In another example, the third-party computing system can include a supplier computing system 118 in which the information 110, 112 is provided by a computing system that provides information to individuals based upon a predetermined criteria, such as advertising, marketing, or other similar computing systems.

In one embodiment, the user can establish an account with the server computing system 106 prior to accessing the server computing system 106. For example, the user can be asked to provide basic demographic information about him or herself, such as the user's interests in information, the types of services or products in which the user may have an interest, or other similar information. This information can be used to create and/or maintain profile data (not shown) for the user.

After an account is established, the user can be asked to login to the system 106 prior to accessing and/or requesting the information 110, 112. The login procedure can be a conventional login procedure as is commonly understood in the art. For example, the login procedure can include asking the user to provide a username or password in order to access and/or request information from the server computing system 106. In one embodiment, the user can connect to the server computing system 106 by entering a uniform resource locator (“URL”) that corresponds to or identifies the server computing system 106 in a browser application or other similar application resident on the hand-held computer 104. Upon establishing a connection with the server computing system 106, any available information 110, 112 can be delivered to the user's hand-held computer 104.

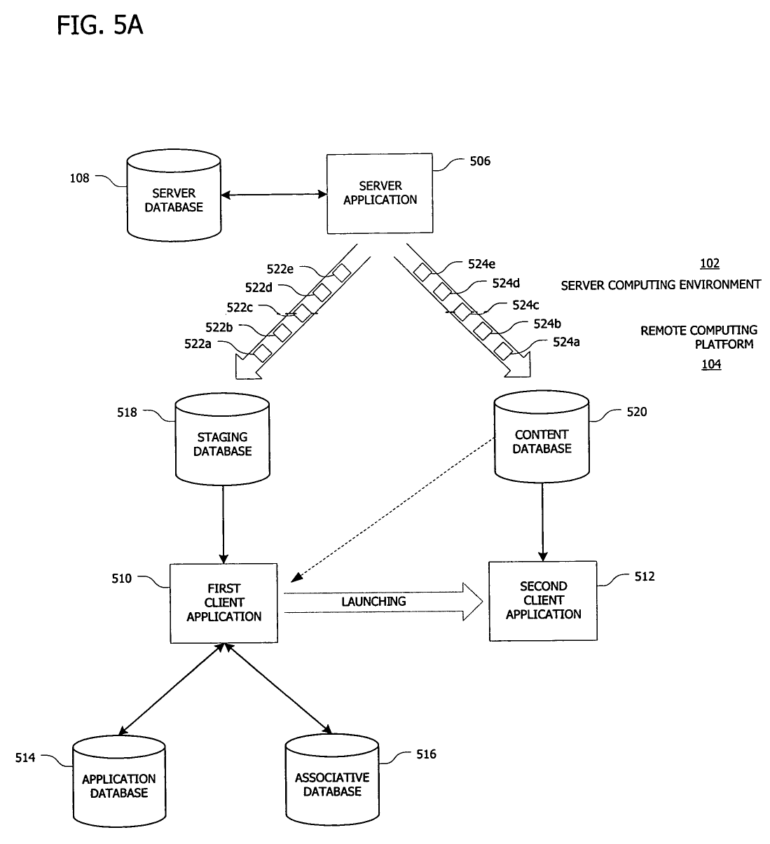

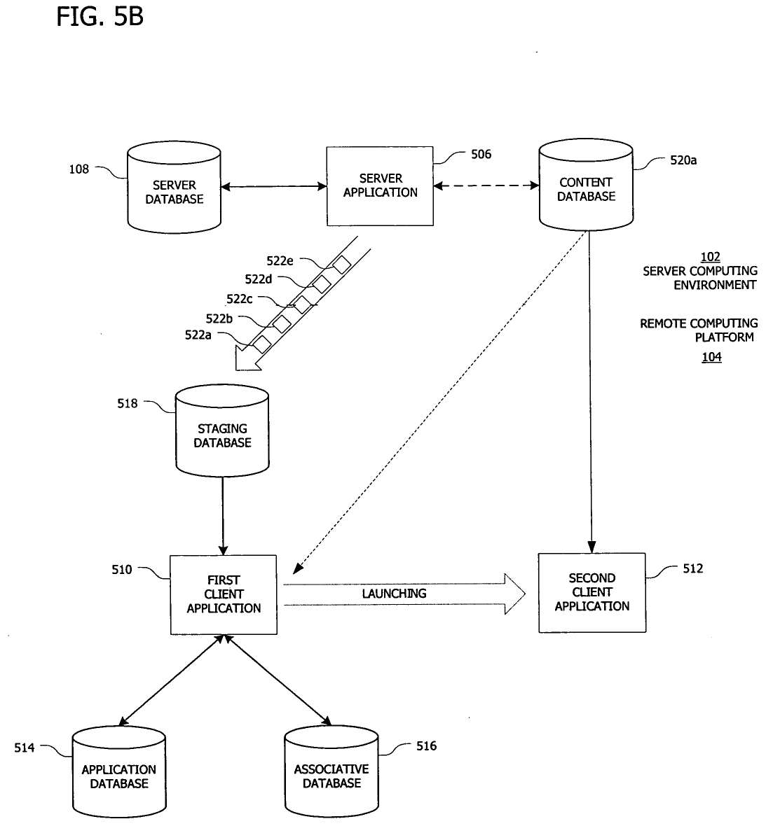

Now referring to FIG. 5A, a block diagram illustrating one embodiment of the computing system for managing information between a server computing environment and a remote computing platform is shown. A server application 506 is resident on the server computing environment 102 and is configured to manage and arrange information relevant to a user stored in a server database 108. The server application 506 is capable of generating and/or compiling information that is relevant to the user. For example, in one embodiment, the server application 506 is capable of generating information relevant to the user. In an alternative embodiment, the server application 506 is capable of receiving and/or aggregating information relevant to the user from third-party computing systems 116, 118 (FIGS. 1 and 4).

Additionally, the server application 506 is also capable of distributing the information from the server computing environment 102 to the remote computing platform 104. Specifically, the server application 506 is configured to distribute information to a staging database 518 and a content database 520 resident on the remote computing platform 104. In one embodiment, the information stored on the server database 108 and distributed to the remote computing platform 104 comprises event information 110 and content information 112 as discussed above. The event information 110 on the server database 108 can include calendar events, news events, stock quote information, flight schedules and/or itineraries, entertainment event listings, as well as other similar information. In the embodiment illustrated in FIG. 5A, the event information includes PIM information, such as calendar events 522a, 522b, 522c, 522d, 522e, or other similar information as described above.

The content information 112 on the server database 108 typically includes detailed information associated with corresponding event information 110. For example, the content information 112 can include detailed information such as detailed flight information, detailed weather information, detailed stock information, detailed information related to goods and/or services available in conjunction with a corresponding event, or other similar information. In the embodiment illustrated in FIG. 5A, the content information 112 distributed to the content database 520 comprises detailed content information 524a, 524b, 524c, 524d, 524e corresponding with each of the calendar events 522a, 522b, 522c, 522d, 522e distributed to the staging database 518.

The event information 522a, 522b, 522c, 522d, 522e distributed from the server computing environment 102 to the staging database 518 can include data in a variety of formats. Table 1 below is an exemplary data structure distributed from the server computing environment 102 to the remote computing platform 104.

TABLE 1

| Data Structure | |
|---|---|
| Field Name | Description |
| <Server_ID> | Identification associated with the |
| | server. |
| <Record_ID> | Identification associated with each |
| | unique event created by client |
| | application on the remote computing |
| | platform. |
| <Content_ID> | Identification associated with |
| | content information corresponding to |
| | a unique event. |
| <Wireless_Content_ID> | Identification associated with |
| | content corresponding to event when |
| | accessed using wireless device. |
| <Event_Start_Month> | Month when the event starts. |
| <Event_Start_Day> | Day when the event starts. |
| <Event_Start_Year> | Year when the event starts. |
| <Event_End_Month> | Month when the event ends. |
| <Event_End_Day> | Day when the event ends. |
| <Event_End_Year> | Year when the event ends. |
| <Event_Start_Hour> | Hour when the event begins. |
| <Event_Start_Min> | Minute when the event begins. |
| <Event_End_Hour> | Hour when the event ends. |
| <Event_End_Min> | Minute when the event ends. |
| <Event_Desc> | String used to describe the event to |
| | the user. |
| <Optional_Note> | Optional character string that can be |
| | attached to the event. |
| <Icon_Flag> | Indicator used to determine whether |
| | an icon should be displayed |
| | proximate with event information. |
| <Alarm_Flag> | Indicator used to activate an alarm |
| | on the remote computing platform. |
| <Alarm_Unit_ID> | Indicator of alarm time units, e.g. |
| | minutes, hours, days. |
| <Alarm_Units_Count> | Number of alarm nits prior to the |
| | appointment start time to activate the |
| | alarm. |

The staging database 518 serves as a temporary storage location for the event information distributed from the server computing environment 102. Eventually, the information from the staging database 518 can be processed or parsed to an application database 514 and an associative database 516 as described in detail below. The application database 514 can be any database accessible and used by a client application 510 operating on the remote computing platform 104. In the illustrated embodiment, the application database 514 comprises application data for calendar applications (e.g., the first client application 510) operating on the remote computing platform 104, such as those sold under the brand names Microsoft Outlook™, Palm Date Book™, or other similar applications. The application database 514 stores information related to one or more events. For example, the application database 514 can store event information that is distributed to the remote computing platform 104 from the server computing environment 102. Alternatively, the application database 514 can store information that is created by the user on the remote computing platform 104. The associative database 516 defines a link or cross-reference between the event information stored on the application database 514 and corresponding content information stored on the content database 520.

In one embodiment, the first client application 510 resident on the remote computing platform 104 is configured to process or parse the event information from the staging database 518 into the application database 514 and the associative database 516. The information processed or parsed from the staging database 518 to the application database 514 can include the following:

<Record_ID>;

<Event_Start_Month>;

<Event_Start_Day>;

<Event_Start_Year>;

<Event_End_Month>;

<Event_End_Day>;

<Event_End_Year>;

<Event_Start_Hour>;

<Event_Start_Min>;

<Event_End_Hour>;

<Event_End_Min>;

<Event_Desc>;

<Optional_Note>;

<Alarm_Flag>;

<Alarm_Unit_ID>; and

<Alarm_Units_Count>.

Similarly, the information processed or parsed from the staging database 518 to the associative database 516 can include the following:

<Server_ID>;

<Record_ID>;

<Content_ID>;

<Wireless_Content_ID>; and

<Icon_Flag>.

The first client application 510 is configured to create a new record and/or modify existing records on the associative database 516 and/or the application database 514. For example, for each event distributed to the staging database 518, the first client application 510 can determine whether the event information already exists on the application database 514 by comparing the unique server identifier and/or the globally unique record identifier (e.g., if a record_id is sent from server) against the records already existing on the associative database 516. If the event information being distributed by the server computing environment 102 does not exist on the application database 514, the first client application 510 will create a new event record on the application database 514 and a new record on the associative database 516. The first client application 510 creates a new event record on the application database 514 by parsing the event specific information (e.g., Event_Start_Month; Event_Start_Day; etc) from the staging database 518 to the application database 514. Each new record created on the application database 514 can be assigned a unique record identifier associated with each unique event. The first client application 510 creates a new record on the associative database 516 by parsing the association information (e.g., Server_ID; Record_ID; Content_ID; and Wireless_Content_ID) from the staging database 518 to the associative database 516.

Conversely, if the event information being distributed by the server computing environment 502 already exists on the application database 514, the first client application 506 will modify the existing event information on the application database 514 and the associative database 516. In particular, the event specific information (e.g., Event_Start_Month; Event_Start_Day; etc) from the staging database 518 will replace the event information already on the application database 514 corresponding with the same event record.

Each record on the associative database 516 defines an association between the event information distributed from the server database 108 and corresponding content information distributed to the content database 520. In this embodiment, the record on the associative database 516 defines a unique identifier, link or cross-reference between the event information stored on the application database 514 and corresponding content information stored on the content database 520. For example, in one embodiment, the association can be a unique identifier corresponding to content information distributed to the content database 520, such as a universal resource locator that identifies a web page that provides additional content information associated with the event information.

Furthermore, it should be understood that if an association exists for a given event, the association can be represented as a graphical representation, such as an icon or other similar representation, arranged and situated proximate to the event information being displayed to the user. Thus, the user can select the graphical representation to access the corresponding detailed content information 112. Upon selecting the graphical representation of the association, the first client application 510 is configured to allow the user to access the content information corresponding to the selected event (e.g., using the Content_ID on the associative database). For example, in one embodiment, the first client application 510 is configured to launch a second client application 512, such as a browser application or other similar application capable of providing access to the content information when the user requests access to the information using the association created by the first client application 510. The second client application 512 can access the content database 520 and display the content information 112 corresponding to the selected event information 110. In an alternative embodiment, the content information is requested and retrieved directly to the first client application 510 when the user requests access to the content information using the association created by the client application 510. In this embodiment, the user can access the content information from within the first client application 510. As a result, the computing system of the present disclosure distributes information from the server computing system 102 and allows the user to easily access detailed content information associated with that information without having to manually input or otherwise manipulate the data on the remote computing platform 104.

Moreover, because each record distributed to the remote computing platform 104 from the server computing environment 102 has a unique server identifier, the computing system for managing information relevant to the user is able to identify the information distributed from the server computing environment 102 independent of the information created by the user and also stored in the application database 514. Accordingly, the server application 506 can be configured to process predetermined calendar events in which the server application 506 processes only that information on the remote computing platform 104 that was distributed by the server computing environment 102. In so doing, the server application 506 does not access or read the information created by the user and stored on the application database 514. As a result, the user's personal information (e.g., information created by the user that is outside the scope of the server computing system 106 or generated and provided by another computing system) remains private.

Furthermore, the computing system of the present disclosure is capable of distributing only discreet amounts of information between the server computing environment 102 and the remote computing platform 104. As a result, the server computing environment can be configured to exchange predetermined information with the remote computing platform 104. Namely, the server computing environment 102 distributes to the remote computing platform 104 available information that has been identified as being relevant to the user as described above. Accordingly, the exchange of information between the server computing environment 102 and the remote computing platform 104 can be targeted and, thus, more time and resource efficient.

It should be noted that in embodiments where the remote computing platform 104 is a wireless communications device, such as a web-enabled cellular phone or other similar device, the remote computing platform 104 can be configured to access content information 112 resident on the server computing environment 102. As shown in FIG. 5B, the event information 522a, 522b, 522c, 522d, 522e is distributed to the remote computing platform 104 as discussed above. However, in this embodiment, when the user requests access to the content information 112 using the association created by the first client application 510, the content information 112 is retrieved from the server computing environment 102 (e.g., using the Wireless_ID on the associative database). Specifically, the remote computing platform 104 can be configured to access a content database 520a resident on the server computing environment 102. The content database 520a can be in data communication with the server application 506, one of the third party computing systems 116, 118, or any other computing system accessible using the remote computing platform 104. Furthermore, as discussed above, the content information 112 retrieved from the content database 520a can be displayed within a second client application 512 launched by the first client application 510 or it can be requested by and retrieved directly to the first client application 510. In so doing, the user can easily access detailed content information 112 associated with one or more events 110 stored on the server computing environment without having to manually input or otherwise manipulate the data on the remote computing platform 104.

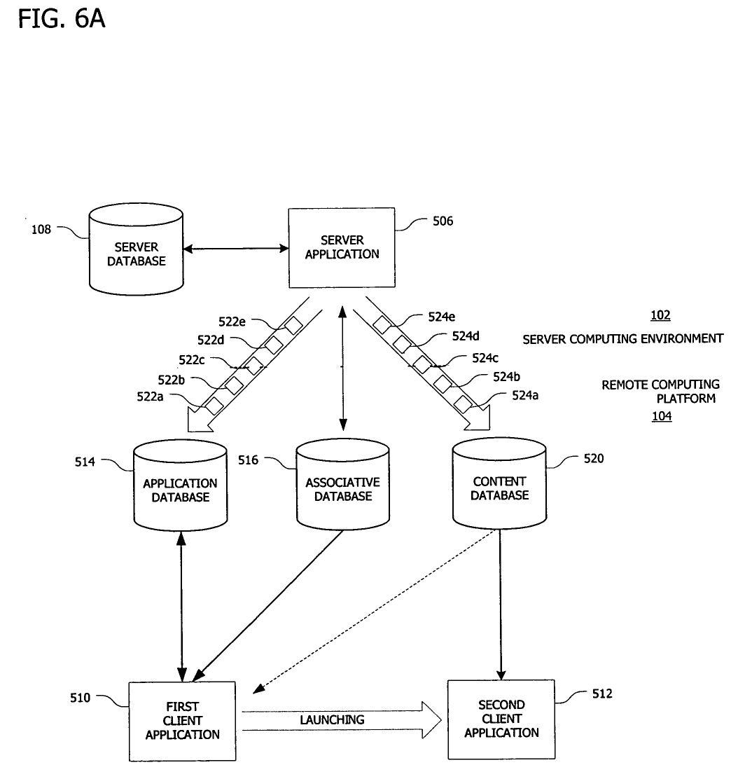

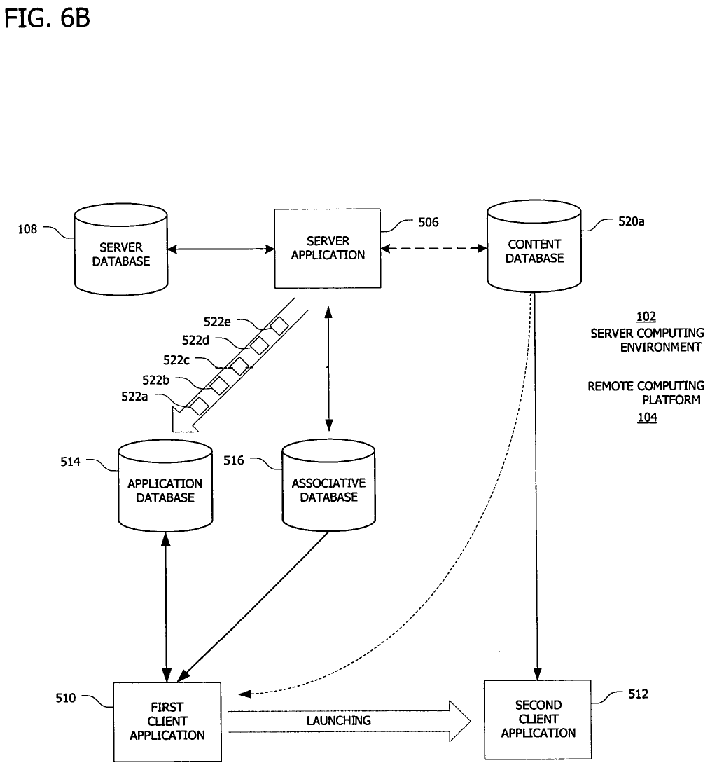

FIG. 6A is a block diagram illustrating a second embodiment of the computing system for managing information between a server computing environment and a remote computing platform. In this embodiment, the server application 506 distributes event information stored on the server database 108 from the server computing environment 102 to the remote computing platform 104 directly to the application database 514. The information stored on the server database 108 and distributed to the application database 514 comprises event information and content information. The event information on the server database 108 can include calendar events, news events, stock quote information, flight schedules and/or itineraries, entertainment event listings, as well as other similar information. In the embodiment illustrated in FIG. 6A, the event information includes PIM information, such as calendar events 522a, 522b, 522c, 522d, 522e, or other similar information.

The content information on the server database 108 includes information that is typically associated with one or more corresponding events, such as detailed information related to the flight, goods and/or services available in conjunction with the flight, or other similar information. In the embodiment illustrated in FIG. 6A, the content information distributed to the content database 520 comprises detailed content information 524a, 524b, 524c, 524d, 524e corresponding with each of the calendar events 522a, 522b, 522c, 522d, 522e distributed to the application database 514. For example, each of the calendar event 518a, 518b, 518c, 518d, 518e can be associated with corresponding detailed content information 524a, 524b, 524c, 524d, 524e.

As shown, the server application 506 is configured to process or parse the event information from the server database 108 into the application database 514. In particular, the server application 506 is configured to create a new record and/or modify existing records on the application database 514. Furthermore, the server application 506 is configured to create a new record and/or modify existing records on the associative database 516. For example, for each event being distributed to the application database 514, the server application 506 can determine whether the event information already exists on the application database 514 by comparing the unique server identifier and/or the globally unique record identifier against those already existing on the application database 514. If the event information being distributed by the server computing environment 102 does not exist on the application database 514, the server application 506 will create a new event record on the application database 514 and a new record on the associative database 516. Conversely, if the event information being distributed by the server computing environment 102 already exists on the application database 514, the server application 506 will modify the existing event information on the application database 514.

Furthermore, the server application 506 is configured to create a record on the associative database 516. Each record on the associative database 516 defines an association between the event information distributed from the server database 108 and corresponding content information distributed to the content database 520. The record on the associative database 516 defines a link or cross-reference between the event information stored on the application database 514 and corresponding content information stored on the content database 520. For example, in one embodiment, the association can be a unique identifier corresponding to content information distributed to the content database 520, such as a universal resource locator that identifies a web page that provides additional content information associated with the event information.

Furthermore, it should be understood that the association can be represented as a graphical representation, such as an icon or other similar representation, arranged and situated proximate to the event information being displayed to the user. Thus, the user can select the graphical representation of the association to access the corresponding detailed content information. Upon selecting the graphical representation of the association, the first client application 510 is configured to allow the user to access the content information corresponding to the selected event. For example, in one embodiment, the first client application 510 is configured to launch a second client application 512 to provide access to the content information 112 when the user requests access to the information using the association created by the first client application 510. The second client application 512 can access the content database 520 and display the content information 112 corresponding to the selected event information 110. In an alternative embodiment, the content information 112 is requested by and retrieved directly to the first client application 510 when the user requests access to the content information using the association created by the client application. In this embodiment, the user can access the content information from within the first client application 510. As a result, the computing system of the present disclosure distributes information from the server computing system 506 and allows the user to easily access detailed content information associated with that information without having to manually input or otherwise manipulate the data on the remote computing platform 104.

Moreover, because each record distributed to the remote computing platform 104 from the server computing environment 102 has a unique server identifier, the computing system for managing information relevant to the user is able to identify the information distributed from the server computing environment 102 independent of the information created by the user and also stored in the application database 514. Accordingly, the server application 506 can be configured to process predetermined calendar events in which the server application 506 processes only that information on the remote computing platform 104 that was distributed by the server computing environment 102. In so doing, the server application 506 does not access or read the information created by the user and stored on the application database 514. As a result, the user's personal information (e.g., information created by the user outside the scope of the server computing system 106 or generated and provided by another computing system) remains private.

It should be noted that in embodiments where the remote computing platform 104 is a wireless communications device, such as a web-enabled cellular phone or other similar device, the remote computing platform 104 can be configured to access content information 112 resident on the server computing environment 102. As shown in FIG. 6B, the event information 522a, 522b, 522c, 522d, 522e is distributed to the remote computing platform 104 as discussed above. However, in this embodiment, when the user requests access to the content information 112 using the association created by the first client application 510, the content information 112 can be retrieved from the server computing environment 102 (e.g., using the Wireless_ID on the associative database). Specifically, the remote computing platform 104 can be configured to access a content database 520a resident on the server computing environment 102. The content database 520a can be in data communication with the server application 506, one of the third party computing systems 116, 118, or any other computing system accessible using the remote computing platform 104. Furthermore, as discussed above, the content information 112 can be displayed within a second client application 512 launched by the first client application 510 or requested by and retrieved directly to the first client application 510. In so doing, the user can easily access detailed content information 112 associated with one or more events 110 stored on the server computing environment without having to manually input or otherwise manipulate the data on the remote computing platform 104.

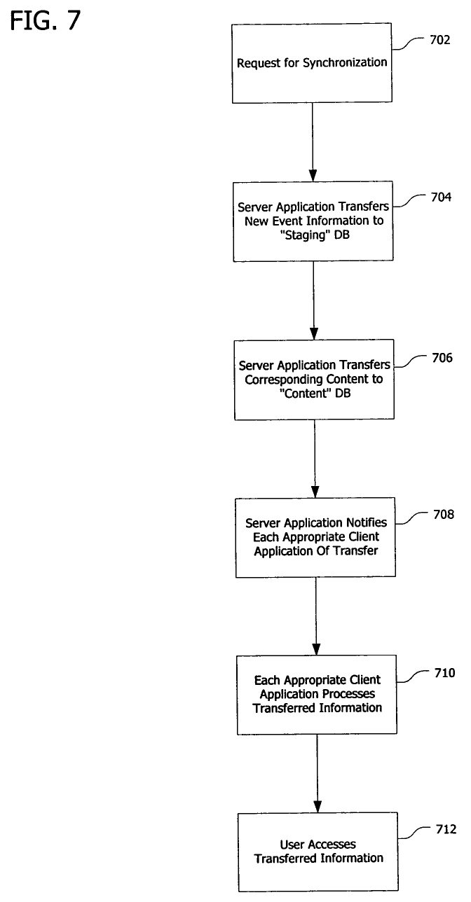

FIG. 7 illustrates a high-level flow diagram of the logical operations of the computing system for managing information between a server computing environment and a remote computing platform in accordance with the present disclosure. As shown in FIG. 7, the client application 510 resident on the remote computing platform 104 typically begins when the user initiates a request to synchronize 702 his/her hand-held computer with the server application 506 resident on the server computing environment 102. In one embodiment, the synchronization process proceeds where the server application 506 distributes or transfers 704 the new event information to the staging database 518 on the remote computing platform 104. Similarly, the server application 506 also distributes the corresponding content information 112 to the content database 520 resident on the remote computing platform 706. After the information is distributed from the server computing environment 102 to the remote computing platform 104, the server application 506 notifies each appropriate client application of the transfer of information 708. Thereafter, each appropriate client application on the remote computing platform is able to process the transferred information 710. Once each client application has processed the applicable information, the user is able to access 712 the information distributed from the server computing environment 102 to the remote computing platform 104.

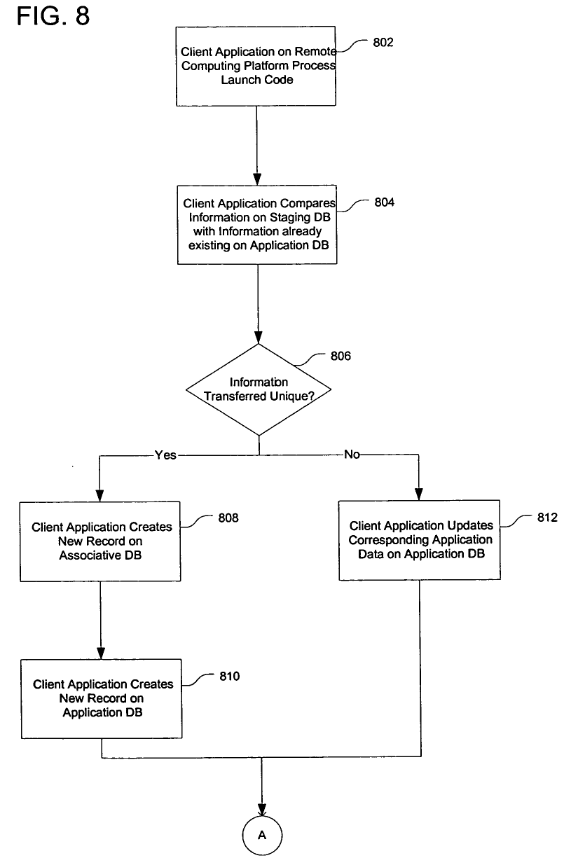

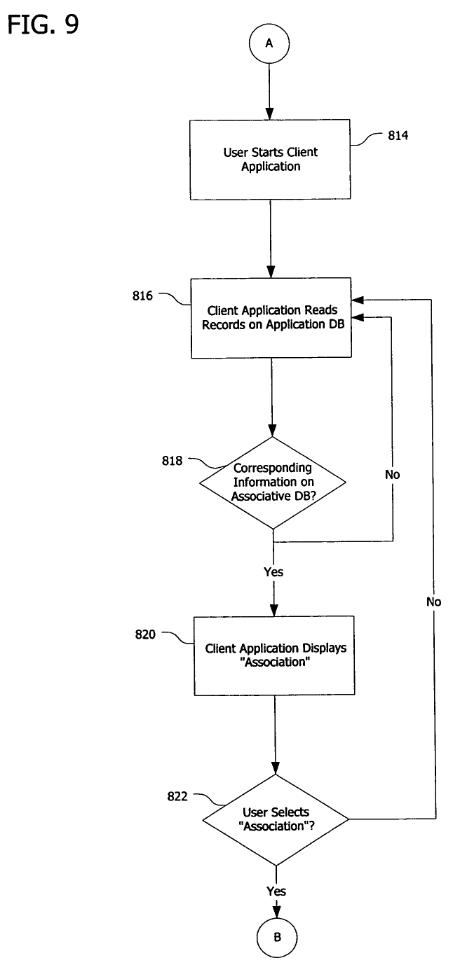

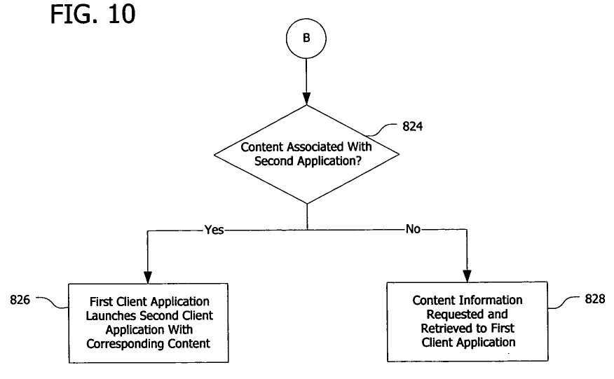

FIGS. 8-10 illustrate a more detailed logic flow diagram of the logic followed by the one embodiment of the computing system of the present disclosure. After the information has been distributed to the remote computing platform 104 from the server computing environment 102, the server application 506 sets an appropriate launch code on the remote computing platform 802. As described above, the server application 506 sets a launch code for each application that it has distributed information. The launch code is an indicator or flag that, when set to a certain value, triggers a corresponding application to perform a certain operation. Once the client application recognizes the launch code, the client application processes 804 the information from the staging database 518 to the application database 514 and the associative database 516.

Operation 806 determines whether the information distributed to the remote computing platform 104 from the server computing environment 102 is unique. If the information is unique, the client application 510 creates a new record on the associative database 808. As discussed above, each record on the associative database 516 defines an association between the event information 110 distributed from the server database 108 and corresponding content information 112 distributed to the content database 520. The record on the associative database 516 defines a link or cross-reference between the event information 110 stored on the application database 514 and corresponding content information 112 stored on the content database 520. In addition to creating a new record on the associative database 516, the client application 510 creates a new record on the application database 810. Conversely, if the information distributed from the server computing environment 102 is not unique, the client application 510 updates the corresponding information on the application database and/or the associative database with the information from the server database 812.

Once the information in the application database 514 has been either created or modified, the user can start the client application 814. The client application 510 is configured to read the records on the application database 816. For each record on the application database 514, operation 818 determines if a corresponding record exists on the associative database 516 identifying an association or link to additional or corresponding content information on the content database. If no corresponding record exists on the associative database 516, the client application 510 displays the information to the user and continues to read the records on the application database 816 as requested by the user. If a corresponding record exists on the associative database 516, the client application 510 can display the association 820 to the user proximate to the event information. For example, the association can be represented as a graphical icon that the user can select to display the corresponding content information.

Operation 822 determines whether the user has selected the association related to the event information. If the user does not select the association, the client application 510 displays the event information to the user and continues to read the records on the application database 816 as requested by the user. If the user does select the association, operation 824 determines whether the content information is associated with a second client application 512. If the content is associated with a second client application 512, the first client application 510 launches the second client application 512 with the corresponding content information 826. Alternatively, if the content is not associated with a second client application 512, the first client application 510 can request and retrieve the content information directly to the first client application 828.

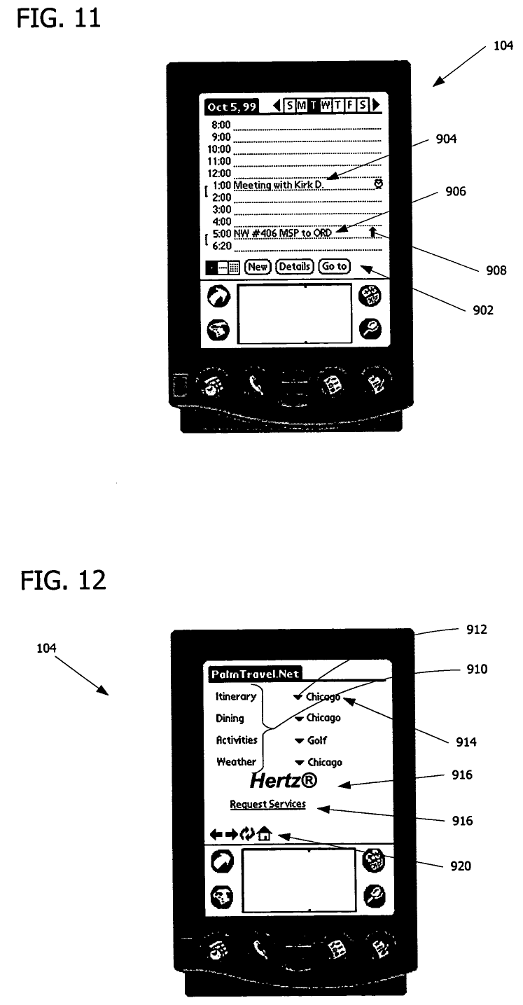

Now referring to FIGS. 11-16, various embodiments of a remote computing platform having a client application capable of receiving information from a server computing platform are shown. For example, FIG. 11 is an exemplary screen representation showing a hand-held computer 104 having a standard PIM calendar application running thereon. As shown, the PIM calendar application includes standard PIM options 902. Event information 904, 906 has been delivered to the hand-held computer 104 from a server computing platform (not shown) and is displayed and accessible via the PIM calendar application. A GUI representation 908 is provided and is associated with available content information corresponding to the event information 906 being displayed to the user. When the user selects the GUI representation 908, the PIM calendar application launches a second client application (not shown) to provide access to the content information corresponding to the event information 906 as shown in FIG. 12 discussed below.

FIG. 12 is an exemplary screen representation showing a hand-held computer 104 providing access to content information associated with the event information 906 displayed in the PIM calendar application discussed above. In the illustrated embodiment, the content information is accessible using a second client application (e.g., 512), such as a business application, launched when the user selects an association provided by the first client application (e.g., 510). However, it should be understood that the content information can be made available by requesting and retrieving the content information directly to the first client application (e.g., 510). Categories 910 are available to organize the content information associated with the event information 906. Each of the categories 910 provides access points, such as GUI element 912, to allow the user to access the content information. For example, when the user selects GUI element 912, a pull-down list of options associated with each category is presented. The items represented by the data 914 are the choices the user has made from the pull-down lists. Additionally, in one embodiment, the user can view more detailed information associated with the choice 914 by selecting the choice 914 in a conventional manner, such as by clicking on the text or otherwise selecting the text. Alternatively, the user can view more detailed information associated with the choice 914 by selecting the corresponding category 910.

An advertisement 916 can be provided to identify a product or service that compliments the content information. While the illustrated embodiment shows the advertisement 916 provided with the content information, it should be understood that a similar advertisement can be provided adjacent to or in association with the event information. Moreover, the user can request additional services or products by selecting button 918. When the user selects button 918, a form (FIG. 4) corresponding to the content information is displayed to the user. For example, a form can be launched as part of a separate application or loaded in the currently running application. One or more Navigation elements 920 can also be provided to allow the user to navigate between various screens of information. For example, each of the navigation elements 920 can include a back navigation element, forward navigation element, a home element, or other similar navigation elements. The specific navigations elements 920 or options can vary according to the specific application launched to display the content information.

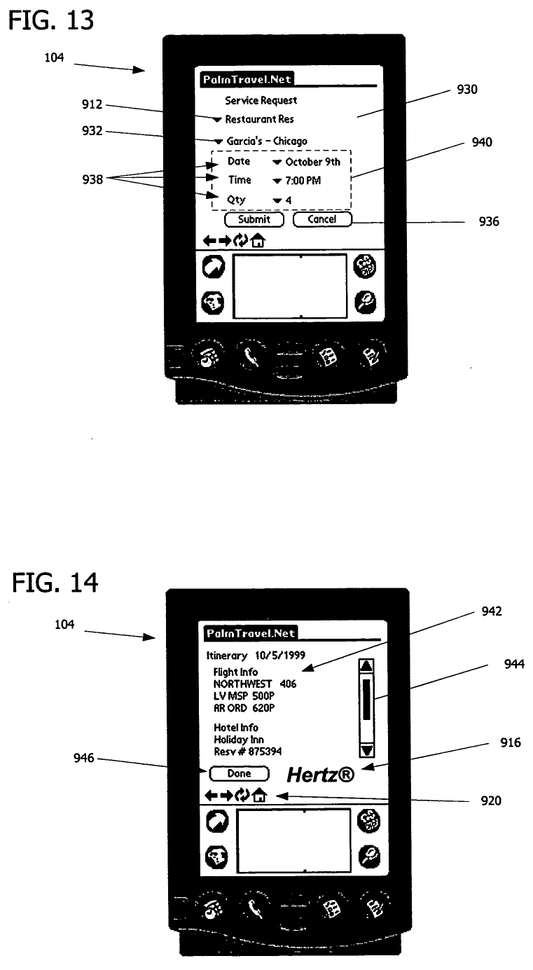

FIG. 13 is an exemplary screen representation showing a hand-held computer 104 providing a services request form 930 that can be completed by the user and submitted to the server computing platform. For example, when the user selects GUI element 912, a pull-down list of service options is presented to the user. Similarly, when the user selects GUI element 932, a pull-down list of variables associated with each service option is presented to the user. However, it should be understood that the information presented in the form can be organized in any suitable manner allowing the user complete and submit the service request form 930. The user can provide service request detail information by using one or more of the pull-down or pop-up lists elements 940. Alternatively, the user can provide detail information by manually entering the information in an appropriate location. The user can cancel the submission of the service request by selecting the button 936.

The form 930 can be returned to the server computing system in the manner described above. Furthermore, it should be understood that the forms provided by the computing system can be any form suitable for allowing the user to access and/or input information that can be returned to the server computing system. Moreover, the forms can be different based upon the user's connection status, such as whether the user is working on-line connection or working off-line connection. Similarly, these forms can vary based on the service option chosen.

FIG. 14 is an exemplary screen representation showing a hand-held computer 104 providing a detailed content information, such as a travel itinerary 942, associated with the event information 906. The illustrated embodiment provides a navigation element, such as scroll bar 944. The scroll bar 944 allows the user to scroll up or down to view the itinerary information. In one embodiment, the user can request service by selecting the service provide icon 916 as described above. Service requests that are processed by the remote computing platform can be added to the itinerary 942 through out the trip. An updated itinerary will be created and submitted to the server computing platform as described above.

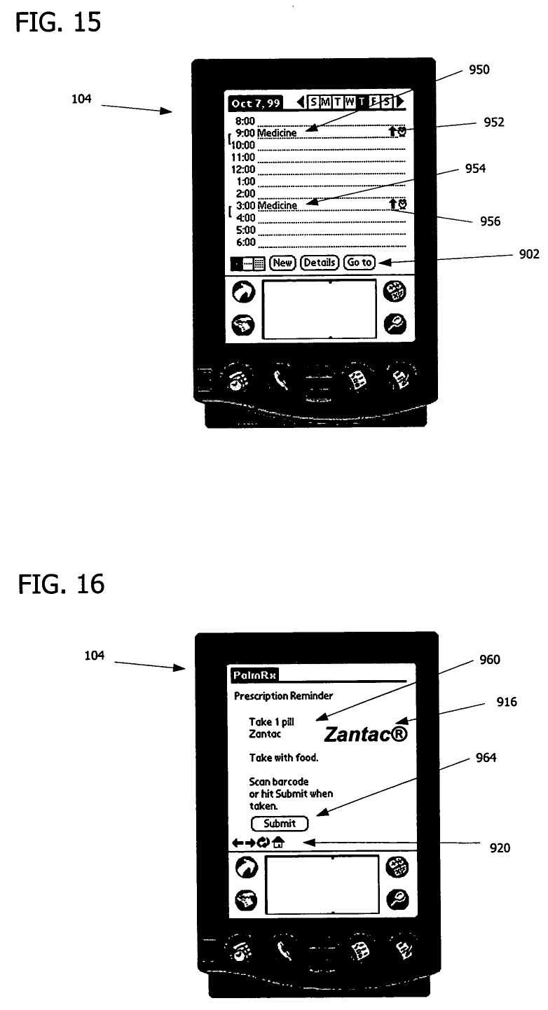

FIG. 15 is a second exemplary screen representation showing a hand-held computer 104 having a standard PIM calendar application running thereon. As shown, the PIM calendar application includes standard PIM options 902. Event information 950, 954 has been delivered to the hand-held computer 104 from a server computing platform (not shown) and is displayed and accessible via the PIM calendar application. A corresponding GUI representation 952, 956 can be provided and associated with available content information corresponding to the event information 950, 954 being displayed to the user. When the user selects one of the GUI representations 952, 956 the PIM calendar application can launch a second client application (not shown) to provide access to the content information corresponding to the event information 906 as shown in FIG. 16 discussed below.

FIG. 16 is an exemplary screen representation showing a hand-held computer 104 providing access to content information associated with the event information 950, 954 displayed in the PIM calendar application discussed above in connection with FIG. 15. In the illustrated embodiment, the PIM calendar application launches a second application when a user selects one of the GUI representations 952, 956. Additionally, the button 964 is used to create a record associated with the corresponding event information 950, 954 to indicate that the user has successfully completed a task. For example, in the illustrated embodiment, the content information associated with the event information 950, 954 reminds the user to take his/her medication. After the user takes the medication, he/she can indicate that the medication has been taken by selection button 964. Furthermore, this information can be returned to the server computing system when the hand-held computer 104 is re-connected to the server computing platform.

The following examples are meant to illustrate some of the possible embodiments of the computing system of the present disclosure. Reference to various examples does not limit the scope of the computing system.

### EXAMPLE 1

In one embodiment, the computing system can be used by a travel industry company that creates reservations for a client and, thus, has an itinerary for that client. This itinerary is delivered to the hand-held computer as a form or as stand-alone information. The itinerary information, for example the flight numbers, arrival and departure times, hotel name, and car rental company name, is automatically written into the calendar application on the hand-held computer. The user could view the detailed itinerary information by selecting any entry in the calendar that is part if the itinerary. Furthermore, the user can view information provided by the server computing system that relates to a specific itinerary. Examples of this information include events and services located in the travel destination cities. For example, the detail information can be related to restaurants located in the travel destination cities. Each restaurant listing can provide additional detailed information, such as menu information and wine list information.

Furthermore, a form, such as a reservation request form, can be provided. The reservation request form can be completed by the user on the remote computing platform and returned to the server computing system for further processing. Alternatively, the request can be transmitted to a service desk for manual processing.

### EXAMPLE 2

In another example, the server computing system can distribute announcement information to the remote computing platform. For example, the server computing system can distribute movie video rental information, music releases, movies released to theaters, concert schedules and other similar events. In this example, the information provided by the server computing system can be a part of an existing customer loyalty or customer history tracking program.

For example, in the case where the announcement information relates to movie video rental, the video store can have catalog profile information for the user such as a unique customer identifier, movie rental history including the genre of the movies rented by the customer, or information provided by the user such as movie genre, favorite actors, or a default store. In one embodiment, the server computing system can deliver announcement information to the user's remote computing platform. For example, the server computing system can deliver announcement information directly to the user's PIM calendar application. The announcement information can notify the user of a movie or video that is being released that meets the user's interests as defined by their profile. Furthermore, in another embodiment, the user can select the item on their PIM calendar application and access more information related to that movie. The user can add the movie to a watch list maintained on their hand-held computer and the IMS server computing system or video company computing system.

Moreover, the information on the user's watch list can be used by the video store to offer additional promotional offers to the user via the server computing application. For example, the video store can offer discounts or options to reserve copies of the video. These offers can be automated forms attached to the information delivered to the user that would be automatically delivered to the user's default store location when the user connects to the server computing system.

### EXAMPLE 3

In another example, the server computing system can distribute medication/medical information to the remote computing platform. For example, the server computing system can provide the user with time reminders related to when predetermined medications should be consumed over a treatment period. In one embodiment, the calendar application can remind the user to take the prescribed medication and/or provide usage and/or dosage information. Similarly, the calendar application can provide a feedback form where the user can indicate whether any side effects occurred as a result of taking the medication or if the symptoms persist. Furthermore, the user can provide indicate that the medication has been consumed or that the correct medication has been taken. For example, the user can scan a barcode on the medication bottle to confirm the correct medication was taken. This scanned entry can be time date stamped and could be communicated back to the physician upon the next visit as a step in measuring the effectiveness of the user's reaction to treatment.

### EXAMPLE 4

In another example, the server computing system can distribute reminder information to the remote computing platform. For example, the server computing system can deliver reminders to the user related to a doctor's or dentist's appointment, scheduled automobile service intervals, or reserved appointment times, such as golf tee-times. Similarly, the server computing system can deliver a user's class schedule. In this example, the user can receive constant updates. For example, the user can receive current postings of homework assignments and testing schedules. Similarly, the server computing system can deliver an athletic team or league schedule to the remote computing platform.

The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which is set forth in the following claims.

The claimed invention is:

1. A computing system for managing event information between a server computing environment and a remote computing platform, the system comprising:
(a) a server application resident on the server computing environment configured to manage and arrange information relevant to a user stored in a server database, the server application being capable of communicating with the remote computing platform and transferring the information from the server database to the remote computing platform; and
(b) a client application resident on the remote computing platform, the client application being configured to create an association between the information transferred from the server database and one or more corresponding events stored on an application database resident on the remote computing platform, the client application further being configured to display each of the events stored on the application database such that the user can automatically access the information transferred from the server database using the association created by the client application.

2. The computing system of claim 1, wherein the information on the server database includes information relevant to the user received from one or more third-party computing systems.

3. The computing system of claim 1, wherein the remote computing system is configured to access content information resident on the server computing system using the association created by the client application.

4. The computing system of claim 1, wherein the information transferred from the server database to the remote computing platform includes one or more events and content information corresponding to each of the events.

5. The computing system of claim 4, wherein each of the events transferred from the server database are transferred to a staging database resident on the remote computing platform and the content information corresponding to each of the events is transferred to a content database resident on the remote computing platform.

6. The computing system of claim 5, wherein the client application processes the events transferred to the staging database into the application database and creates a record on an associative database for linking each event processed by the client application with the corresponding content information transferred to the content database resident on the remote computing platform.

7. The computing system of claim 6, wherein the record created on the associative database includes a unique identifier corresponding content information transferred to the content database resident on the remote computing platform.

8. The computing system of claim 2, wherein the server application processes the events transferred from the server database into the application database and creates a record on an associative database for linking each event processed by the server application with the corresponding content information transferred to the content database resident on the remote computing platform.

9. The computing system of claim 2, wherein the user can automatically access the content information corresponding to a selected calendar event using the association created by the client application.

10. The computing system of claim 9, wherein the content information is requested and retrieved directly to the client application when the user requests access to the content information using the association created by the client application.

11. The computing system of claim 9, wherein the client application is configured to launch a second client application to provide access to the content information when the user requests access to the information using the association created by the client application.

12. The computing system of claim 1, wherein the information from the server database is transferred to the remote computing platform when the remote computing platform is being synchronized with the server application.

13. The computing system of claim 1, wherein the user can access and update the information stored on the server database when the remote computing platform is on-line.

14. The computing system of claim 13, wherein the client application is further configured to allow the user to request additional information from the server database that is relevant to the information being accessed by the user.

15. The computing system of claim 1, wherein the user can access and update the information transferred from the server database when the remote computing platform is off-line.

16. The computing system of claim 15, wherein the client application is further configured to allow the user to request additional information from the server database that is relevant to the information transferred from the server database, wherein further the additional information from the server database is transferred to the remote computing platform when the remote computing platform is being synchronized with the server application.

17. The computing system of claim 1, wherein the server application updates the information transferred from the server database when the remote computing platform is being synchronized with the server application.

18. The computing system of claim 1, wherein the remote computing platform is a hand-held computer.

19. The computing system of claim 1, wherein the remote computing platform is a wireless communications device.

20. A computing system for managing calendar events between a server computing environment and a remote computing platform, the system comprising:
(a) a server application resident on the server computing environment configured to manage and arrange information relevant to a user stored in a server database, the server application being capable of communicating with the remote computing platform and transferring the information from the server database to the remote computing platform, the server application further being configured to process predetermined calendar events stored in an application database resident on the remote computing platform; and
(b) a client application resident on the remote computing platform, the client application being configured to create an association between the information transferred from the server database and one or more corresponding calendar events stored on the application database resident on the remote computing platform, the client application further being configured to display each of the calendar events stored on the application database such that the user can automatically access the information transferred from the server database using the association created by the client application.

21. A computing system for communicating with a server computing environment, the system comprising:
(a) a portable computing platform, the portable computing platform having a processor and a memory in data communication with the processor;
(b) an application database stored in the memory, the application database for storing one or more events; and
(c) a client application resident on the portable computing platform, the client application being programmed to receive information relevant to a user from the server computing environment, the client application being configured to create an association between the information received from the server computing environment and one or more corresponding events stored on the application database, the client application further being configured to display each of the events stored on the application database such that the user can automatically access the information transferred from the server computing environment using the association created by the client application.

22. A method for managing information between a server computing environment and a remote computing platform, the server computing environment having a server application configured to manage and arrange information relevant to a user stored in a server database, the method comprising:
(a) distributing the information from the server database to the remote computing platform;
(b) creating an association between the information transferred from the server database and one or more corresponding events stored on an application database resident on the remote computing platform; and
(c) displaying each of the events stored on the application database such that the user can automatically access the information transferred from the server database using the association.

23. The method of claim 22, wherein the information on the server database includes information relevant to the user received from one or more third-party computing systems.

24. The method of claim 22, wherein the step of displaying each of the events stored on the application database includes displaying each of the events stored on the application database such that the user can automatically access content information resident on the server computing environment.

25. The method of claim 22, wherein the step of distributing the information from the server database to the remote computing platform includes:
(a) distributing one or more events from the server database to the remote computing platform; and
(b) distributing content information corresponding to each of the events from the server database to the remote computing platform.

26. The method of claim 25, wherein the steps of distributing one or more events from the server database to the remote computing platform and distributing content information corresponding to each of the events from the server database to the remote computing platform further includes:
(a) distributing each of the events to a staging database resident on the remote computing platform; and
(b) distributing the content information to a content database resident on the remote computing platform.

27. The method of claim 26 further comprising:
(a) processing the events transferred to the staging database into the application database; and
(b) linking each event with the corresponding content information transferred to the content database.

28. The method of claim 27, wherein the step of linking each event includes creating a record on an associative database.

29. The method of claim 28, wherein the record created on the associative database includes a unique identifier corresponding to the content information transferred to the content database resident on the remote computing platform.

30. The method of claim 25, wherein the step of distributing the information from the server database to the remote computing platform further includes:
(a) processing the events from the server database into the application database; and
(b) linking each event with the corresponding content information transferred to the content database resident on the remote computing platform.

31. The method of claim 30, wherein the step of linking each event includes creating a record on an associative database.

32. The method of claim 25 further comprising accessing the content information corresponding to a selected event using the association.

33. The method of claim 32 further comprising updating the content information corresponding to a selected event using the association when the remote computing platform is on-line.

34. The method of claim 32 further comprising updating the content information corresponding to a selected event using the association when the remote computing platform is off-line.

35. The method of claim 32, wherein the step of accessing the content information corresponding to a selected event includes requesting and retrieving the content information directly to the client application resident on the remote computing platform when the user requests access to the content information using the association.

36. The method of claim 32, wherein the step of accessing the content information corresponding to a selected event includes launching a second client application with the content information when the user requests access to the content information using the association.

37. The method of claim 22, wherein the step of distributing the information from the server database to the remote computing platform includes distributing the information to the remote computing platform when the remote computing platform is being synchronized With the server application.

38. The method of claim 22 further comprising:
(a) requesting additional information from the server database that is relevant to the information transferred from the server database; and
(b) distributing the additional information from the server database to the remote computing platform when the remote computing platform is being synchronized with the server application.

39. A computer storage medium readable by a computing system and encoding a computer program of instructions for executing a computer process for managing information between a server computing environment and a remote computing platform, the server computing environment having a server application configured to manage and arrange information relevant to a user stored in a server database, the computer process comprising:
(a) distributing the information from the server database to a client application resident on the remote computing platform;
(b) creating an association between the information transferred from the server database and one or more corresponding events stored on an application database resident on the remote computing platform; and
(c) displaying each of the events stored on the application database such that the user can automatically access the information transferred from the server database using the association.

40. The storage medium of claim 39, wherein the information on the server database includes information relevant to the user received from one or more third-party computing systems.

41. The storage medium of claim 39, wherein the step of displaying each of the events stored on the application database includes displaying each of the events stored on the application database such that the user can automatically access content information resident on the server computing environment.

42. The storage medium of claim 39, wherein the step of distributing the information from the server database to the remote computing platform includes:
(a) distributing one or more events from the server database to the remote computing platform; and
(b) distributing content information corresponding to each of the events from the server database to the remote computing platform.

43. The storage medium of claim 42, wherein the steps of distributing one or more events from the server database to the remote computing platform and distributing content information corresponding to each of the events from the server database to the remote computing platform further includes:
(a) distributing each of the events to a staging database resident on the remote computing platform; and
(b) distributing the content information to a content database resident on the remote computing platform.

44. The storage medium of claim 43 further comprising:
(a) processing the events transferred to the staging database into the application database; and
(b) linking each event with the corresponding content information transferred to the content database.

45. The storage medium of claim 44, wherein the step of linking each event includes creating a record on an associative database.

46. The storage medium of claim 45, wherein the record created on the associative database includes a unique identifier corresponding to the content information transferred to the content database resident on the remote computing platform.

47. The storage medium of claim 42, wherein the step of distributing the information from the server database to the remote computing platform further includes:
(a) processing the events from the server database into the application database; and
(b) linking each event with the corresponding content information transferred to the content database resident on the remote computing platform.

48. The storage medium of claim 47, wherein the step of linking each event includes creating a record on an associative database.

49. The storage medium of claim 42 further comprising accessing the content information corresponding to a selected event using the association.

50. The storage medium of claim 49 further comprising updating the content information corresponding to a selected event using the association when the remote computing platform is on-line.

51. The storage medium of claim 49 further comprising updating the content information corresponding to a selected event using the association when the remote computing platform is off-line.

52. The storage medium of claim 49, wherein the step of accessing the content information corresponding to a selected event includes requesting and retrieving the content information directly to the client application resident on the remote computing platform when the user requests access to the content information using the association.

53. The storage medium of claim 49, wherein the step of accessing the content information corresponding to a selected event includes launching a second client application with the content information when the user requests access to the content information using the association.

54. The storage medium of claim 39, wherein the step of distributing the information from the server database to the remote computing platform includes distributing the information to the remote computing platform when the remote computing platform is being synchronized with the server application.

55. The storage medium of claim 39 further comprising:
(a) requesting additional information from the server database that is relevant to the information transferred from the server database; and
(b) distributing the additional information from the server database to the remote computing platform when the remote computing platform is being synchronized with the server application.

56. A propagated signal on a carrier detectable by a computing system and encoding a computer program of instructions for executing a computer process for managing information between a server computing environment and a remote computing platform, the server computing environment having a server application configured to manage and arrange information relevant to a user stored in a server database, the computer process comprising:
(a) distributing the information from the server database to a client application resident on the remote computing platform;
(b) creating an association between the information transferred from the server database and one or more corresponding events stored on an application database resident on the remote computing platform; and
(c) displaying each of the events stored on the application database such that the user can automatically access the information transferred from the server database using the association.

57. The signal of claim 56, wherein the information on the server database includes information relevant to the user received from one or more third-party computing systems.

58. The signal of claim 56, wherein the step of displaying each of the events stored on the application database includes displaying each of the events stored on the application database such that the user can automatically access content information resident on the server computing environment.

59. The signal of claim 56, wherein the step of distributing the information from the server database to the remote computing platform includes:
(a) distributing one or more events from the server database to the remote computing platform; and
(b) distributing content information corresponding to each of the events from the server database to the remote computing platform.

60. The signal of claim 59, wherein the steps of distributing one or more events from the server database to the remote computing platform and distributing content information corresponding to each of the events from the server database to the remote computing platform further includes:
(a) distributing each of the events to a staging database resident on the remote computing platform; and
(b) distributing the content information to a content database resident on the remote computing platform.

61. The signal of claim 60 further comprising:
(a) processing the events transferred to the staging database into the application database; and
(b) linking each event with the corresponding content information transferred to the content database.

62. The signal of claim 61, wherein the step of linking each event includes creating a record on an associative database.

63. The signal of claim 62, wherein the record created on the associative database includes a unique identifier corresponding to the content information transferred to the content database resident on the remote computing platform.

64. The signal of claim 59, wherein the step of distributing the information from the server database to the remote computing platform further includes:
(a) processing the events from the server database into the application database; and
(b) linking each event with the corresponding content information transferred to the content database resident on the remote computing platform.

65. The signal of claim 64, wherein the step of linking each event includes creating a record on an associative database.

66. The signal of claim 59 further comprising accessing the content information corresponding to a selected event using the association.

67. The signal of claim 66 further comprising updating the content information corresponding to a selected event using the association when the remote computing platform is on-line.

68. The signal of claim 66 further comprising updating the content information corresponding to a selected event using the association when the remote computing platform is off-line.

69. The signal of claim 66, wherein the step of accessing the content information corresponding to a selected event includes requesting and retrieving the content information directly to the client application resident on the remote computing platform when the user requests access to the content information using the association.

70. The signal of claim 66, wherein the step of accessing the content information corresponding to a selected event includes launching a second client application with the content information when the user requests access to the content information using the association.

71. The signal of claim 56, wherein the step of distributing the information from the server database to the remote computing platform includes distributing the information to the remote computing platform when the remote computing platform is being synchronized with the server application.

72. The signal of claim 56 further comprising:
(a) requesting additional information from the server database that is relevant to the information transferred from the server database; and
(b) distributing the additional information from the server database to the remote computing platform when the remote computing platform is being synchronized with the server application.
